(19) United States
(12) Patent Application Publication
(10) Pub. No.: US 2016/0147302 A1
(43) Pub. Date: May 26, 2016

(54) DISPLAY DEVICE AND METHOD OF CONTROLLING THE SAME

(71) Applicant: LG ELECTRONICS INC., Seoul (KR)

(72) Inventor: Munseok CHOI, Seoul (KR)

(73) Assignee: LG ELECTRONICS INC., Seoul (KR)

(21) Appl. No.: 14/904,684

(22) PCT Filed: Mar. 21, 2014
(86) PCT No.: PCT/KR2014/002398

§ 371 Date: Jan. 12, 2016

(30) Foreign Application Priority Data
Aug. 19, 2013 (KR) 10-2013-0098044

(51) Int. Cl. G06F 3/01; G02B 27/01

(52) U.S. Cl. CPC G06F 3/013; G02B 27/0101; G02B 27/0176; G02B 2027/0138; G02B 2027/014; G02B 2027/0178

(57) ABSTRACT

The present invention relates to a display device that is capable of being head-mounted and a method of controlling the display device. Provided is a display device including a main body formed in such a manner that the main body can be head-mounted, a display unit arranged in a position that corresponds to left and right eyes configured to display an indicator indicating an occurrence of an event in an external device, and a controller configured to display video information that corresponds to the event that occurs in the external device to the display unit when it is determined that a wearer stares at the indicator for a predetermined time or more.

### TECHNICAL FIELD

The present invention relates to a display device and more particularly to a display device that is capable of being head-mounted and a method of controlling the display device.

### BACKGROUND ART

As the information society develops rapidly, the importance of a display device capable of implementing a screen with a sense of reality is being emphasized. For instance, a head-mounted display (HMD) device is being researched.

The HMD device is mainly implemented as safety goggles or a helmet. Once a user wears the HMD device, the user can see a screen in front of his or her eyes. The HMD device has been developed for realization of a sense of virtual reality. A small display such as a liquid crystal display is installed at the HMD device close to a user's two eyes, so that images can be projected to the display. Recently, the HMD device is being widely developed for use in a space development center, a reactor building, a military agency and a medical institution, for business use or games, etc.

Thanks to these improvements, smart eye-glasses, one example of a head-mounted display device, are on the market. The smart glasses realized as a wearable device conveniently executes a function that is executed in the existing mobile terminal.

On the other hand, there is a problem in that the mobile terminal such as a smart phone cannot be inconveniently used in a situation where the user is doing something with his/her hands, such as while the user is driving or is carrying baggage. Accordingly, there is an increasing need for a technology that enables the user to check a result of an event that occurs in the mobile terminal without having to move his/her hands.

### DISCLOSURE OF INVENTION

### Technical Problem

Therefore, an object of the present invention is to provide a display device that enables a user to check a result of an event that occurs in an external device without having to moving his/her hands for improving user convenience and a method of controlling the display device.

### Solution to Problem

To achieve these and other advantages and in accordance with the purpose of the present invention, as embodied and broadly described herein, there is provided a display device including a main body that is formed in such a manner that the main body can be head-mounted, a display unit that is arranged in a position that corresponds to left and right eyes and on which an indicator indicating an occurrence of an event in an external device is output, and a controller that when it is determined that a wearer stares at the indicator for a predetermined time or more, outputs video information that corresponds to the event that occurs in the external device, on the display unit.

In the embodiment, when it is determined that the wearer stares at the indicator for the predetermined time or more, the controller may request the external device to transmit content information that is output in the external device according to the occurrence of the event and may receive the content information.

In the embodiment, the controller may generate the video information that corresponds to the event that occurs in the external device, based on the received content information, and may output the generated video information, on the display unit.

In the embodiment, when it is determined that the wearer stares at an ending indicator that is output on the display unit, for the predetermined time or more, the controller may end the outputting of the video information.

The embodiment may further include an eye tracking camera that determines whether the wearer stares at the indicator that is output on the display unit, for the predetermined time or more, by keeping track of movements of the wearer's eyes.

In the embodiment, the multiple indicators that correspond to the multiple events, respectively, which occur in the external device, may be output on the display unit, and the controller may output at least one of the items of video information that corresponds to at least one of the indicators, respectively, in order in which the wearer stares at at least one of the multiple indicators for the predetermined time or more.

To achieve these and other advantages and in accordance with the purpose of the present invention, as embodied and broadly described herein, there is provided a method of controlling a display device that is capable of being head-mounted, including a step (a) of outputting an indicator indicating an occurrence of an event in an external device, a step (b) of determining whether the wearer stares at the indicator for a predetermined time or more, and a step (c) of outputting video information that corresponds to the event that occurs in the external device, on the display unit, when it is determined that the wearer stares at the indicator for the predetermined time or more.

In the embodiment, the step (c) may include requesting the external device to transmit content information that is output in the external device according to the occurrence of the event and receiving the content information, when it is determined that the wearer stares at the indicator for the predetermined time or more.

In the embodiment, the step (c) may include generating the video information that corresponds to the event that occurs in the external device, based on the received content information, and outputting the generated video information, on the display unit.

In the embodiment, the step (d) may include ending the outputting of the video information, when it is determined that the wearer stares at an ending indicator that is output on the display unit, for the predetermined time or more.

In the embodiment, the display device that is capable of being head-mounted may include an eye tracking camera that determines whether the wearer stares at the indicator that is output on the display unit, for the predetermined time or more, by keeping track of movements of the wearer's eyes.

In the method, the step (a) may include outputting the multiple indicators that correspond to the multiple events, respectively, which occur in the external device, the step (b) may include determining whether the wearer stares at at least one of the indicators for the predetermined time or more, and the step (c) may include outputting at least one of the items of video information that corresponds to at least one of the indicators, respectively, on the display unit, in order in which the wearer stares at at least one of the multiple indicators.

### Advantageous Effects of Invention

According to the present invention, there is no need for the wearer to apply a separate touch and the like because he/she checks the result of the event that occurs in the external device through the use of the movements of the his/her eyes. In addition, compatibility with various external devices is possible. As a result, the user convenience can be improved.

### BRIEF DESCRIPTION OF DRAWINGS

FIG. 1 is a block diagram illustrating a mobile terminal according to an embodiment of the present invention;

FIGS. 2a and 2b are diagrams illustrating a conceptional framework of a telecommunication system in which the mobile terminal according to the present invention can operate;

FIG. 3 is a diagram illustrating a display device according to one embodiment of the present invention;

FIG. 4 is a flowchart for describing the display device according to one embodiment of the present invention;

FIG. 5 is a diagram illustrating a display device according to one embodiment, associated with receiving of a message;

FIG. 6 is a diagram illustrating a user interface through which the display device according to the present invention operates;

FIG. 7 is a diagram illustrating a display device according to one embodiment, associated with a navigation function;

FIG. 8 is a diagram illustrating a display device according to one embodiment, associated with use of public transportation;

FIG. 9 is a diagram illustrating a display device according to one embodiment, associated with way-finding;

FIG. 10 is a diagram illustrating a display device according to one embodiment, associated with transmission of a screen; and

FIG. 11 is a diagram illustrating a display device according to one embodiment, associated with occurrences of multiple events.

### MODE FOR THE INVENTION

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

Description will now be given in detail according to the exemplary embodiments, with reference to the accompanying drawings. For the sake of brief description with reference to the drawings, the same or equivalent components will be provided with the same reference numbers, and description thereof will not be repeated. A suffix “module” or “unit” used for constituent elements disclosed in the following description is merely intended for easy description of the specification, and the suffix itself does not give any special meaning or function. In describing the present invention, if a detailed explanation for a related known function or construction is considered to unnecessarily divert the gist of the present disclosure, such explanation has been omitted but would be understood by those skilled in the art. The accompanying drawings are used to help easily understood the technical idea of the present invention and it should be understood that the idea of the present disclosure is not limited by the accompanying drawings.

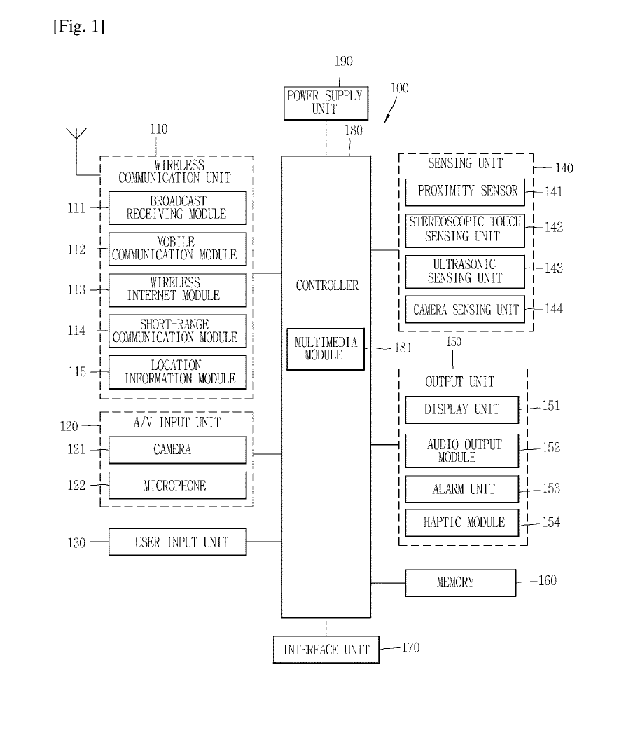

FIG. 1 is a block diagram of a mobile terminal 100 in accordance with one exemplary embodiment.

The mobile terminal 100 may comprise components, such as a wireless communication unit 110, an Audio/Video (A/V) input unit 120, a user input unit 130, a sensing unit 140, an output unit 150, a memory 160, an interface unit 170, a controller 180, a power supply 190 and the like. FIG. 1B shows the mobile terminal 100 having various components, but it is understood that implementing all of the illustrated components is not a requirement. Greater or fewer components may alternatively be implemented.

In addition, the display device 100 is named the mobile terminal.

Hereinafter, each component 110 to 190 is described in sequence.

The wireless communication unit 110 may typically include one or more modules which permit wireless communications between the mobile terminal 100 and a wireless communication system or between the mobile terminal 100 and a network within which the mobile terminal 100 is located. For example, the wireless communication unit 110 may include at least one of a broadcast receiving module 111, a mobile communication module 112, a wireless Internet module 113, a short-range communication module 114, a location information module 115 and the like.

The broadcast receiving module 111 receives a broadcast signal and/or broadcast associated information from an external broadcast managing entity via a broadcast channel.

The broadcast channel may include a satellite channel and a terrestrial channel. The broadcast managing entity may indicate a server which generates and transmits a broadcast signal and/or broadcast associated information or a server which receives a pre-generated broadcast signal and/or broadcast associated information and sends them to the mobile terminal. The broadcast signal may be implemented as a TV broadcast signal, a radio broadcast signal, and a data broadcast signal, among others. The broadcast signal may further include a data broadcast signal combined with a TV or radio broadcast signal.

Examples of broadcast associated information may include information associated with a broadcast channel, a broadcast program, a broadcast service provider, and the like. The broadcast associated information may be provided via a mobile communication network, and received by the mobile communication module 112.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module 111 may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) and the like. The broadcast receiving module 111 may be configured to be suitable for every broadcast system transmitting broadcast signals as well as the digital broadcasting systems.

Broadcast signals and/or broadcast associated information received via the broadcast receiving module 111 may be stored in a suitable device, such as a memory 160.

The mobile communication module 112 transmits/receives wireless signals to/from at least one of network entities (e.g., base station, an external mobile terminal, a server, etc.) on a mobile communication network. Here, the wireless signals may include audio call signal, video (telephony) call signal, or various formats of data according to transmission/reception of text/multimedia messages.

The mobile communication module 112 may implement a video call mode and a voice call mode. The video call mode indicates a state of calling with watching a callee's image. The voice call mode indicates a state of calling without watching the callee's image. The wireless communication module 112 may transmit and receive at least one of voice and image in order to implement the video call mode and the voice call mode.

The wireless Internet module 113 supports wireless Internet access for the mobile terminal. This module may be internally or externally coupled to the mobile terminal 100. Examples of such wireless Internet access may include Wireless LAN (WLAN) (Wi-Fi), Wireless Broadband (Wibro), Worldwide Interoperability for Microwave Access (Wimax), High Speed Downlink Packet Access (HSDPA) and the like.

The short-range communication module 114 denotes a module for short-range communications. Suitable technologies for implementing this module may include BLUETOOTH™, Radio Frequency IDentification (RFID), Infrared Data Association (IrDA), Ultra-WideBand (UWB), ZigBee™, Near Field Communication (NFC) and the like.

The location information module 115 denotes a module for detecting or calculating a position of a mobile terminal. An example of the location information module 115 may include a Global Position System (GPS) module.

Still referring to FIG. 1, the A/V input unit 120 is configured to provide audio or video signal input to the mobile terminal. The A/V input unit 120 may include a camera 121 and a microphone 122. The camera 121 receives and processes image frames of still pictures or video obtained by image sensors in a video call mode or a capturing mode. The processed image frames may be displayed on a display unit 151.

The image frames processed by the camera 121 may be stored in the memory 160 or transmitted to the exterior via the wireless communication unit 110. Also, user's position information and the like may be calculated from the image frames acquired by the camera 121. Two or more cameras 121 may be provided according to the configuration of the mobile terminal.

The microphone 122 may receive an external audio signal while the mobile terminal is in a particular mode, such as a phone call mode, a recording mode, a voice recognition mode, or the like. This audio signal is processed into digital data. The processed digital data is converted for output into a format transmittable to a mobile communication base station via the mobile communication module 112 in case of the phone call mode. The microphone 122 may include assorted noise removing algorithms to remove noise generated in the course of receiving the external audio signal.

The user input unit 130 may generate input data input by a user to control the operation of the mobile terminal. The user input unit 130 may include a keypad, a dome switch, a touchpad (e.g., static pressure/capacitance), a jog wheel, a jog switch and the like.

The sensing unit 140 provides status measurements of various aspects of the mobile terminal. For instance, the sensing unit 140 may detect a location of the mobile terminal 100, a presence or absence of user contact with the mobile terminal 100, the location of the mobile terminal 100, acceleration/deceleration of the mobile terminal 100, and the like, so as to generate a sensing signal for controlling the operation of the mobile terminal 100. Other examples include sensing functions, such as the sensing unit 140 sensing the presence or absence of power provided by the power supply 190, the presence or absence of a coupling or other connection between the interface unit 170 and an external device.

The output unit 150 is configured to output an audio signal, a video signal or a tactile signal. The output unit 150 may include a display unit 151, an audio output module 153, an alarm unit 154 and a haptic module 155.

The display unit 151 may output information processed in the mobile terminal 100. For example, when the mobile terminal is operating in a phone call mode, the display unit 151 will provide a User Interface (UI) or a Graphic User Interface (GUI), which includes information associated with the call. As another example, if the mobile terminal is in a video call mode or a capturing mode, the display unit 151 may additionally or alternatively display images captured and/or received, UI, or GUI.

The display unit 151 may be implemented using, for example, at least one of a Liquid Crystal Display (LCD), a Thin Film Transistor-Liquid Crystal Display (TFT-LCD), an Organic Light-Emitting Diode (OLED), a flexible display, a three-dimensional (3D) display, an e-ink display or the like.

Some of such displays 151 may be implemented as a transparent type or an optical transparent type through which the exterior is visible, which is referred to as ‘transparent display’. A representative example of the transparent display may include a Transparent OLED (TOLED), and the like. The rear surface of the display unit 151 may also be implemented to be optically transparent. Under this configuration, a user can view an object positioned at a rear side of a terminal body through a region occupied by the display unit 151 of the terminal body.

The display unit 151 may be implemented in two or more in number according to a configured aspect of the mobile terminal 100. For instance, a plurality of the displays 151 may be arranged on one surface to be spaced apart from or integrated with each other, or may be arranged on different surfaces.

The display unit 151 may also be implemented as a stereoscopic display unit 152 for displaying stereoscopic images.

Here, the stereoscopic image may be a three-dimensional (3D) stereoscopic image, and the 3D stereoscopic image is an image refers to an image making a viewer feel that a gradual depth and reality of an object on a monitor or a screen is the same as a reality space. A 3D stereoscopic image is implemented by using binocular disparity. Binocular disparity refers to disparity made by the positions of two eyes. When two eyes view different 2D images, the images are transferred to the brain through the retina and combined in the brain to provide the perception of depth and reality sense.

The stereoscopic display unit 152 may employ a stereoscopic display scheme such as stereoscopic scheme (a glass scheme), an auto-stereoscopic scheme (glassless scheme), a projection scheme (holographic scheme), or the like. Stereoscopic schemes commonly used for home television receivers, or the like, include Wheatstone stereoscopic scheme, or the like.

The auto-stereoscopic scheme includes, for example, a parallax barrier scheme, a lenticular scheme, an integral imaging scheme, or the like. The projection scheme includes a reflective holographic scheme, a transmissive holographic scheme, or the like.

In general, a 3D stereoscopic image is comprised of a left image (a left eye image) and a right image (a right eye image). According to how left and right images are combined into a 3D stereoscopic image, the 3D stereoscopic imaging method is divided into a top-down method in which left and right images are disposed up and down in a frame, an L-to-R (left-to-right, side by side) method in which left and right images are disposed left and right in a frame, a checker board method in which fragments of left and right images are disposed in a tile form, an interlaced method in which left and right images are alternately disposed by columns and rows, and a time sequential (or frame by frame) method in which left and right images are alternately displayed by time.

Also, as for a 3D thumbnail image, a left image thumbnail and a right image thumbnail are generated from a left image and a right image of the original image frame, respectively, and then combined to generate a single 3D thumbnail image. In general, thumbnail refers to a reduced image or a reduced still image. The thusly generated left image thumbnail and the right image thumbnail are displayed with a horizontal distance difference therebetween by a depth corresponding to the disparity between the left image and the right image on the screen, providing a stereoscopic space sense.

As illustrated, a left image and a right image required for implementing a 3D stereoscopic image is displayed on the stereoscopic display unit 152 by a stereoscopic processing unit (not shown). The stereoscopic processing unit may receive the 3D image and extract the left image and the right image, or may receive the 2D image and change it into a left image and a right image.

Here, if the display unit 151 and a touch sensitive sensor (referred to as a touch sensor) have a layered structure therebetween (referred to as a ‘touch screen’), the display unit 151 may be used as an input device as well as an output device. The touch sensor may be implemented as a touch film, a touch sheet, a touchpad, and the like.

The touch sensor may be configured to convert changes of a pressure applied to a specific part of the display unit 151, or a capacitance occurring from a specific part of the display unit 151, into electric input signals. Also, the touch sensor may be configured to sense not only a touched position and a touched area, but also touch pressure. Here, a touch object is an object to apply a touch input onto the touch sensor. Examples of the touch object may include a finger, a touch pen, a stylus pen, a pointer or the like.

When touch inputs are sensed by the touch sensors, corresponding signals are transmitted to a touch controller. The touch controller processes the received signals, and then transmits corresponding data to the controller 180. Accordingly, the controller 180 may sense which region of the display unit 151 has been touched.

Still referring to FIG. 1, a proximity sensor 141 may be arranged at an inner region of the mobile terminal 100 covered by the touch screen, or near the touch screen. The proximity sensor 141 may be provided as one example of the sensing unit 140. The proximity sensor 141 indicates a sensor to sense presence or absence of an object approaching to a surface to be sensed, or an object disposed near a surface to be sensed, by using an electromagnetic field or infrared rays without a mechanical contact. The proximity sensor 141 has a longer lifespan and a more enhanced utility than a contact sensor.

The proximity sensor 141 may include a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this case, the touch screen (touch sensor) may be categorized into a proximity sensor.

Hereinafter, for the sake of brief explanation, a status that the pointer is positioned to be proximate onto the touch screen without contact will be referred to as ‘proximity touch’, whereas a status that the pointer substantially comes in contact with the touch screen will be referred to as ‘contact touch’. For the position corresponding to the proximity touch of the pointer on the touch screen, such position corresponds to a position where the pointer faces perpendicular to the touch screen upon the proximity touch of the pointer.

The proximity sensor 141 senses proximity touch, and proximity touch patterns (e.g., distance, direction, speed, time, position, moving status, etc.). Information relating to the sensed proximity touch and the sensed proximity touch patterns may be output onto the touch screen.

When a touch sensor is overlaid on the stereoscopic display unit 152 in a layered manner (hereinafter, referred to as ‘stereoscopic touch screen’), or when the stereoscopic display unit 152 and a 3D sensor sensing a touch operation are combined, the stereoscopic display unit 152 may also be used as a 3D input device.

As examples of the 3D sensor, the sensing unit 140 may include a proximity sensor 141, a stereoscopic touch sensing unit 142, an ultrasonic sensing unit 143, and a camera sensing unit 144.

The proximity sensor 141 detects the distance between a sensing object (e.g., the user's finger or a stylus pen) applying a touch by using the force of electromagnetism or infrared rays without a mechanical contact and a detect surface. By using the distance, the terminal recognizes which portion of a stereoscopic image has been touched. In particular, when the touch screen is an electrostatic touch screen, the degree of proximity of the sensing object is detected based on a change of an electric field according to proximity of the sensing object, and a touch to the 3D image is recognized by using the degree of proximity.

The stereoscopic touch sensing unit 142 is configured to detect the strength or duration of a touch applied to the touch screen. For example, the stereoscopic touch sensing unit 142 may sense touch pressure. When the pressure is strong, it may recognize the touch as a touch with respect to an object located farther away from the touch screen toward the inside of the terminal.

The ultrasonic sensing unit 143 is configured to recognize position information of the sensing object by using ultrasonic waves.

The ultrasonic sensing unit 143 may include, for example, an optical sensor and a plurality of ultrasonic sensors. The optical sensor is configured to sense light and the ultrasonic sensors may be configured to sense ultrasonic waves. Since light is much faster than ultrasonic waves, a time for which the light reaches the optical sensor is much shorter than a time for which the ultrasonic wave reaches the ultrasonic sensor. Therefore, a position of a wave generation source may be calculated by using a time difference from the time that the ultrasonic wave reaches based on the light as a reference signal.

The camera sensing unit 144 includes at least one of a camera 121, a photo sensor, and a laser sensor.

For example, the camera 121 and the laser sensor may be combined to detect a touch of the sensing object with respect to a 3D stereoscopic image. When distance information detected by a laser sensor is added to a 2D image captured by the camera, 3D information can be obtained.

In another example, a photo sensor may be laminated on the display device. The photo sensor is configured to scan a movement of the sensing object in proximity to the touch screen. In detail, the photo sensor includes photo diodes and transistors at rows and columns to scan content mounted on the photo sensor by using an electrical signal changing according to the quantity of applied light. Namely, the photo sensor calculates the coordinates of the sensing object according to variation of light to thus obtain position information of the sensing object.

The audio output module 153 may convert and output as sound audio data received from the wireless communication unit 110 or stored in the memory 160 in a call signal reception mode, a call mode, a record mode, a voice recognition mode, a broadcast reception mode, and the like. Also, the audio output module 153 may provide audible outputs related to a particular function performed by the mobile terminal 100 (e.g., a call signal reception sound, a message reception sound, etc.). The audio output module 153 may include a speaker, a buzzer or the like.

The alarm unit 154 outputs a signal for informing about an occurrence of an event of the mobile terminal 100. Events generated in the mobile terminal may include call signal reception, message reception, key signal inputs, a touch input etc. In addition to video or audio signals, the alarm unit 154 may output signals in a different manner, for example, using vibration to inform about an occurrence of an event. The video or audio signals may be also outputted via the audio output module 153, so the display unit 151 and the audio output module 153 may be classified as parts of the alarm unit 154.

A haptic module 155 generates various tactile effects the user may feel. A typical example of the tactile effects generated by the haptic module 155 is vibration. The strength and pattern of the haptic module 155 can be controlled. For example, different vibrations may be combined to be outputted or sequentially outputted.

Besides vibration, the haptic module 155 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 155 may be implemented to allow the user to feel a tactile effect through a muscle sensation such as fingers or arm of the user, as well as transferring the tactile effect through a direct contact. Two or more haptic modules 155 may be provided according to the configuration of the mobile terminal 100.

The memory 160 may store software programs used for the processing and controlling operations performed by the controller 180, or may temporarily store data (e.g., a phonebook, messages, still images, video, etc.) that are inputted or outputted. In addition, the memory 160 may store data regarding various patterns of vibrations and audio signals outputted when a touch is inputted to the touch screen.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating the authority of using the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the terminal 100 via the interface unit 170.

When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

Also, the controller 180 may execute a lock state to restrict a user from inputting control commands for applications when a state of the mobile terminal meets a preset condition. Also, the controller 180 may control a lock screen displayed in the lock state based on a touch input sensed on the display unit 151 in the lock state of the mobile terminal.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For software implementation, the embodiments such as procedures or functions described herein may be implemented by separate software modules. Each software module may perform one or more functions or operations described herein.

Software codes can be implemented by a software application written in any suitable programming language. The software codes may be stored in the memory 160 and executed by the controller 180.

Hereinafter, a communication system which is operable with the mobile terminal 100 according to the present disclosure will be described.

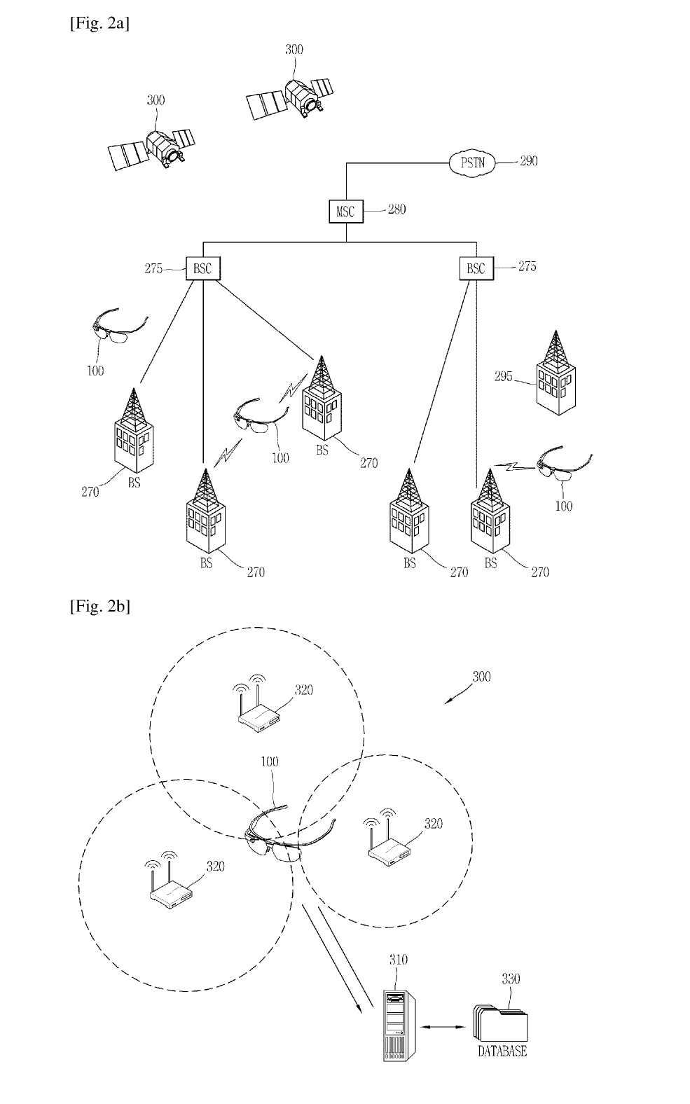

FIGS. 2A and 2B are conceptual views of a communication system operable with a mobile terminal in accordance with the present disclosure.

First, referring to FIG. 2A, such communication systems utilize different air interfaces and/or physical layers. Examples of such air interfaces utilized by the communication systems include Frequency Division Multiple Access (FDMA), Time Division Multiple Access (TDMA), Code Division Multiple Access (CDMA), and Universal Mobile Telecommunications System (UMTS), the Long Term Evolution (LTE) of the UMTS, the Global System for Mobile Communications (GSM), and the like.

By way of non-limiting example only, further description will relate to a CDMA communication system, but such teachings apply equally to other system types including the CDMA wireless communication system.

Referring now to FIG. 2A, a CDMA wireless communication system is shown having a plurality of mobile terminals 100, a plurality of base stations (BSs) 270, base station controllers (BSCs) 275, and a mobile switching center (MSC) 280. The MSC 280 is configured to interface with a conventional Public Switch Telephone Network (PSTN) 290. The MSC 280 is also configured to interface with the BSCs 275. The BSCs 275 are coupled to the base stations 270 via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs 275 can be included in the system as shown in FIG. 2A.

Each base station 270 may include one or more sectors, each sector having an omnidirectional antenna or an antenna pointed in a particular direction radially away from the base station 270. Alternatively, each sector may include two or more different antennas. Each base station 270 may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations 270 may also be referred to as Base Station Transceiver Subsystems (BTSs). In some cases, the term “base station” may be used to refer collectively to a BSC 275, and one or more base stations 270. The base stations may also be denoted as “cell sites.” Alternatively, individual sectors of a given base station 270 may be referred to as cell sites.

A broadcasting transmitter (BT) 295, as shown in FIG. 2A, transmits a broadcast signal to the mobile terminals 100 operating within the system. The broadcast receiving module 111 (FIG. 1B) is typically configured inside the mobile terminal 100 to receive broadcast signals transmitted by the BT 295.

FIG. 2A further depicts several Global Positioning System (GPS) satellites 300. Such satellites 300 facilitate locating the position of at least one of plural mobile terminals 100. Two satellites are depicted in FIG. 2, but it is understood that useful position information may be obtained with greater or fewer satellites than two satellites. The GPS module 115 (FIG. 1B) is typically configured to cooperate with the satellites 300 to obtain desired position information. It is to be appreciated that other types of position detection technology, (i.e., location technology that may be used in addition to or instead of GPS location technology) may alternatively be implemented. If desired, at least one of the GPS satellites 300 may alternatively or additionally be configured to provide satellite DMB transmissions.

During typical operation of the wireless communication system, the base stations 270 receive sets of reverse-link signals from various mobile terminals 100. The mobile terminals 100 are engaging in calls, messaging, and executing other communications. Each reverse-link signal received by a given base station 270 is processed within that base station 270. The resulting data is forwarded to an associated BSC 275. The BSC 275 provides call resource allocation and mobility management functionality including the orchestration of soft handoffs between base stations 270. The BSCs 275 also route the received data to the MSC 280, which then provides additional routing services for interfacing with the PSTN 290. Similarly, the PSTN 290 interfaces with the MSC 280, and the MSC 280 interfaces with the BSCs 275, which in turn control the base stations 270 to transmit sets of forward-link signals to the mobile terminals 100.

Hereinafter, description will be given of a method for acquiring location information of a mobile terminal using a wireless fidelity (WiFi) positioning system (WPS), with reference to FIG. 2B.

The WiFi positioning system (WPS) 300 refers to a location determination technology based on a wireless local area network (WLAN) using WiFi as a technology for tracking the location of the mobile terminal 100 using a WiFi module provided in the mobile terminal 100 and a wireless access point 320 for transmitting and receiving to and from the WiFi module.

The WiFi positioning system 300 may include a WiFi location determination server 310, a mobile terminal 100, a wireless access point (AP) 320 connected to the mobile terminal 100, and a database 330 stored with any wireless AP information.

The WiFi location determination server 310 extracts the information of the wireless AP 320 connected to the mobile terminal 100 based on a location information request message (or signal) of the mobile terminal 100. The information of the wireless AP 320 may be transmitted to the WiFi location determination server 310 through the mobile terminal 100 or transmitted to the WiFi location determination server 310 from the wireless AP 320.

The information of the wireless AP extracted based on the location information request message of the mobile terminal 100 may be at least one of MAC address, SSID, RSSI, channel information, privacy, network type, signal strength and noise strength.

The WiFi location determination server 310 receives the information of the wireless AP 320 connected to the mobile terminal 100 as described above, and compares the received wireless AP 320 information with information contained in the pre-established database 330 to extract (or analyze) the location information of the mobile terminal 100.

On the other hand, referring to FIG. 2B, as an example, the wireless AP connected to the mobile terminal 100 is illustrated as a first, a second, and a third wireless AP 320. However, the number of wireless APs connected to the mobile terminal 100 may be changed in various ways according to a wireless communication environment in which the mobile terminal 100 is located. When the mobile terminal 100 is connected to at least one of wireless APs, the WiFi positioning system 300 can track the location of the mobile terminal 100.

Next, considering the database 330 stored with any wireless AP information in more detail, various information of any wireless APs disposed at different locations may be stored in the database 330.

The information of any wireless APs stored in the database 330 may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like.

In this manner, any wireless AP information and location information corresponding to the any wireless AP are stored together in the database 330, and thus the WiFi location determination server 310 may retrieve wireless AP information corresponding to the information of the wireless AP 320 connected to the mobile terminal 100 from the database 330 to extract the location information matched to the searched wireless AP, thereby extracting the location information of the mobile terminal 100.

Furthermore, the extracted location information of the mobile terminal 100 may be transmitted to the mobile terminal 100 through the WiFi location determination server 310, thereby acquiring the location information of the mobile terminal 100.

Hereinafter, a display device according to an embodiment of the present disclosure as illustrated in FIG. 1B or a display device having constituent elements thereof or the structure of a display device will be described.

FIG. 3 is a diagram illustrating the display device 100 according to one embodiment of the present invention.

Referring to FIG. 3, the display device 100 according to the present invention includes a main body 310, the display unit 151 and the controller 180.

The display device 100 according to the present invention is realized as a head-mounted display (HMD) device. As a specific example, the display device 100 according to the present invention is realized as smart glasses.

The main body 310 is formed in such a manner that the main body 310 can be head-mounted. For example, the main body 310 is realized as a frame of the smart glasses.

The display unit 151 is coupled to the main body 310 in such a manner that the display unit 151 is arranged in a position corresponding to the left and right eyes. An indicator, indicating that an event occurs in an external device is output on the display unit 151.

At this point, the external device includes mobile terminals such as a mobile phone, a smart phone, a laptop computer, a digital-broadcast-dedicated terminal, a personal digital assistant (PDA), a portable multimedia player (PMP), a navigation system, a slate PC, a tablet PC, and a Ultrabook. However, except for the mobile terminal, it is apparent to a person of ordinary skill in the art that a configuration according to embodiments described in the present specification is applicable to stationary terminals such as a digital TV set and a desktop computer.

The controller 180 controls the display device 100. Specifically, when it is determined that the wearer stares at the indicator, for a predetermined time or more, video information corresponding to the event that occurs in the external device is output on the display unit.

In addition, the controller 180 is mounted on the main body 310 of the display device 100 or the controller 180 and the main body 310 are formed into one piece. As another embodiment, the controller 180 may be arranged away from the main body 310.

The camera 121 is arranged in front of at least one of the left-eye and right-eye display units 151. Alternatively, one camera 121 is arranged in one side of the frame 310 or the two cameras 121 are arranged in both sides of the frame 310, respectively, to photograph an object that is out of the wearer's field of view.

An eye tracking camera 340 keeps track of movements of the wearer's eyes and determines whether the wearer stares at the indicator, that is output on the display unit 151, for the predetermined time or more.

Specifically, the multiple eye tracking cameras 340 are attached to the left-eye and right-eye display units 151, respectively, to keep track of each of the movements of the left and right eyes. Alternatively, the eye tracking camera is mounted within the display unit 151.

The user input 130 is realized, as a separate touch panel, on one side of the frame 310, or the user inputs 130 are realized, as separate touch panels, on both sides of the frame 310, respectively. Alternatively, the user input 130 is realized as a physical key. For example, an ON/Off switch for a power source is realized on one side of the frame 310.

As another embodiment, the user input unit 130 may be realized as a separate external device that connects to the main body 310. Accordingly, the user can input a specific command into the separate external device. Alternatively, the display unit 151 is realized as a touch screen and thus the user can directly input a control command into the display unit 151.

As one example of the head-mounted display device, the smart eye-glasses are on the market. The smart glasses realized as a wearable device conveniently executes a function that is executed in the existing mobile terminal.

On the other hand, there is a problem in that the mobile terminal such as the smart phone cannot be inconveniently used in a situation where the user is doing something with his/her hands, such as while the user is driving or is carrying baggage. Accordingly, there is an increasing need for a technology that enables the user to check a result of the event that occurs in the mobile terminal without having to move his/her hands.

Accordingly, the display device 100 that is capable of checking a result of the event that occurs in the external device through the use of movements of the wearer's eyes for improving user convenience and a method of controlling the display device 100 are described below referring to the accompanying drawings.

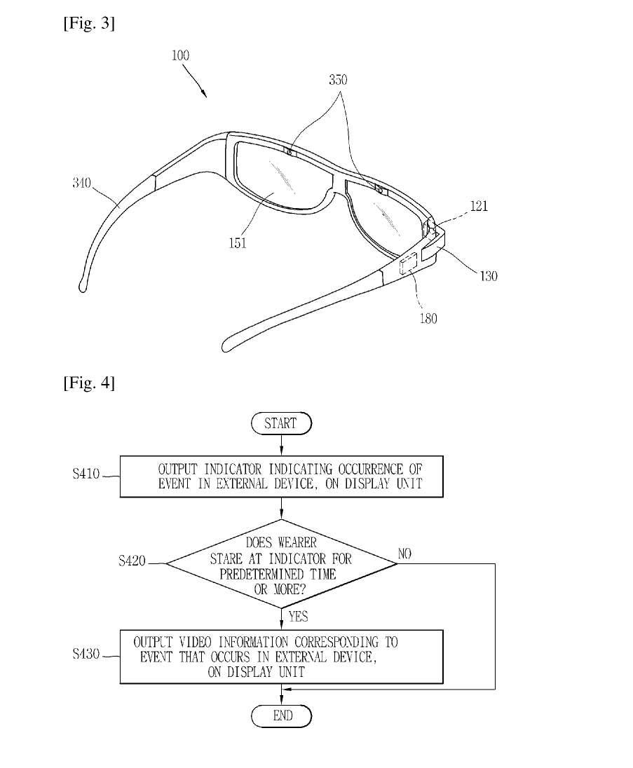

FIG. 4 is a flowchart for describing the display device 100 (refer to FIG. 1) according to one embodiment of the present invention. The display device 100 includes the main body 310, the display unit 151, and the controller 180.

Referring to FIG. 4, first, a step (S410) of outputting the indicator indicating the occurrence of the event in the external device on the display unit 151 proceeds.

Subsequently, a step (S420) of determining whether the wearer stares at the indicator for the predetermined time or more proceeds.

When it is determined that the wearer stares at the indicator for the predetermined time or more, a step (S430) of outputting the video information corresponding to the event that occurs in the external device on the display unit 151 proceeds.

In contrast, when it is not determined that the wearer stares at the indicator for the predetermined time or more, an entire process is ended.

For example, when the wearer stares at the indicator for less than the predetermined time or does not stare at the indicator, the entire process is ended.

On the other hand, when it is determined that the wearer stares at the indicator for the predetermined time or more, the external device is requested to transmit content information that is output in the external device according to the occurrence of the event and the content information is received.

Subsequently, the video information that corresponds to the event that occurs in the external device is generated based on the received content information and the generated video information is output on the display unit 151.

In addition, when it is determined that the wearer stares at an ending indication that is output on the display unit 151, for the predetermined time or more, the outputting of the video information is ended.

FIG. 5 is a diagram illustrating a display device according to one embodiment, associated with receiving of a message.

Referring to FIG. 5(a), the message is received at a mobile terminal 510, the carried external device. Specifically, contents of the received message are output as content information 520 according to a message receiving event that occurs in a mobile terminal 510.

Referring to FIG. 5(b), an indicator 530 that corresponds to the message receiving event occurring in the mobile terminal 510 is output on the display unit 151 of smart glasses 100 that is worn by the user. Specifically, a notification of the occurrence of the message receiving event is transmitted from the mobile terminal 510 and the indicator 530 corresponding to the notification is output on the display unit 151.

At this time, the indicator 530 is output in various shapes. For example, the indicator 530 is output as a letter envelope icon or a messenger icon that indicates the receiving of the message. In addition, the indicator 530 is output in bright color or with a blinking image effect in order to draw the attention of the wearer and is output on each of the left-eye and right-eye display units 151.

On the other hand, through the use of an eye tracking camera 540 that is attached to a rim 310 of the smart glasses 100, it is determined whether the wearer stares at the indicator 530 for the predetermined time or more.

As an embodiment, the multiple eye tracking cameras 540 may be attached to each of the left-eye and right-eye display units 151 and thus the movements of the left and right eyes can be recognized more effectively.

As another embodiment, the eye tracking camera 540 may be mounted within the display unit 151.

FIG. 5(c) is a diagram illustrating a screen 151 when viewed from the wearer.

Referring to FIG. 5(c), when it is determined through the use of the eye tracking camera 540 that the wearer stares at the indicator 530 for the predetermined time or more, the mobile terminal 510 is requested to transmit the content information 520 that is output in the mobile terminal 510 according to the occurrence of the event, and then the content information 520 is received.

Subsequently, video information 550 that corresponds to the message receiving event that occurs in the mobile terminal 510 is output on the display unit 151, based on the received content information 520.

Specifically, a message receiving screen 520, as is, which is output in the mobile terminal 510 is output as the video information 550 that is output on the display unit 151. Alternatively, the message receiving screen 520 that is output in the mobile terminal 510 is edited, and thus the video information 550 is generated and then is output.

As an embodiment, of the message receiving screen 520 that is output in the mobile terminal 510, only one region including a recently-received message may be output as the video information 550.

As another embodiment, considering a size of the screen 151, only a name or only an ID and contents of conversation may be briefly output except for a photo of a message sender that is output in the mobile terminal 510.

As another embodiment, of the message receiving screen 520 that is output in the mobile terminal 510, an attached file such as an image or a document may be briefly output on the display unit 151.

At this time, the mobile terminal 510 and the smart glasses 100 are wirelessly connected to each other with DLNA or WiDI, the mobile terminal 510 is requested to transmit the content information 520 and the smart glasses 100 receive the content information 520.

Referring to FIG. 5(d), when it is determined that the wearer stares at an ending indication 560 that is output in the display unit 151, for the predetermined time or more, the outputting of the video information 550 that is output on the display unit 151 is ended.

Like the indicator 530 described above, the ending indication 560 is output in bright color and with a blinking image effect in order to draw attention of the wearer and are output on each of the left-eye and light-eye display units 151.

As another embodiment, when the wearer stares at empty space on the display unit 151 on which any information is output or when the wearer does not stare at the video information 550 even one time for the predetermined time, the outputting of the video information 550 that is output on the display unit 151 may be ended.

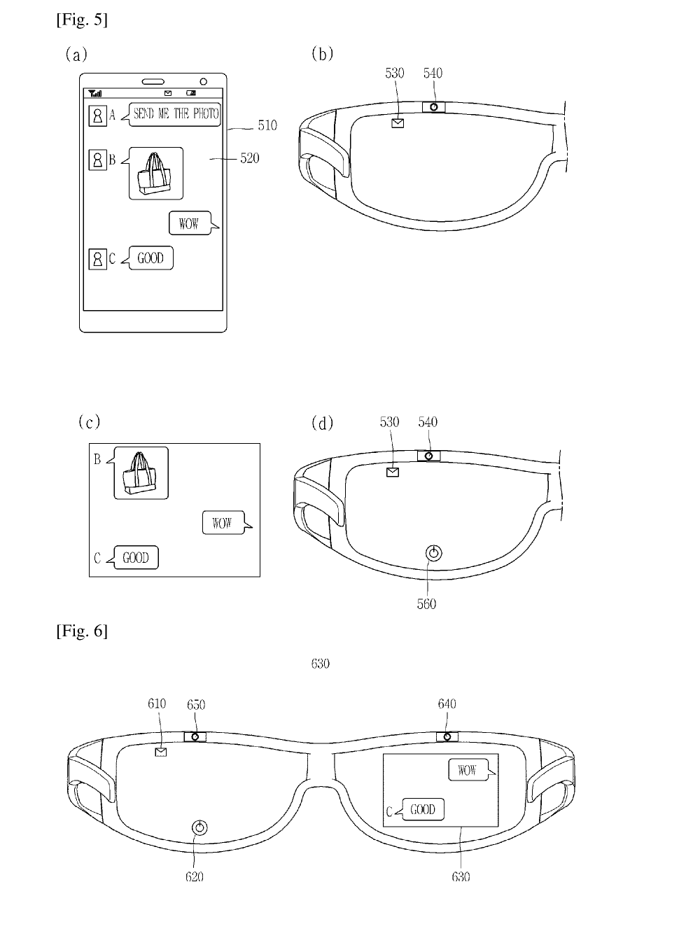

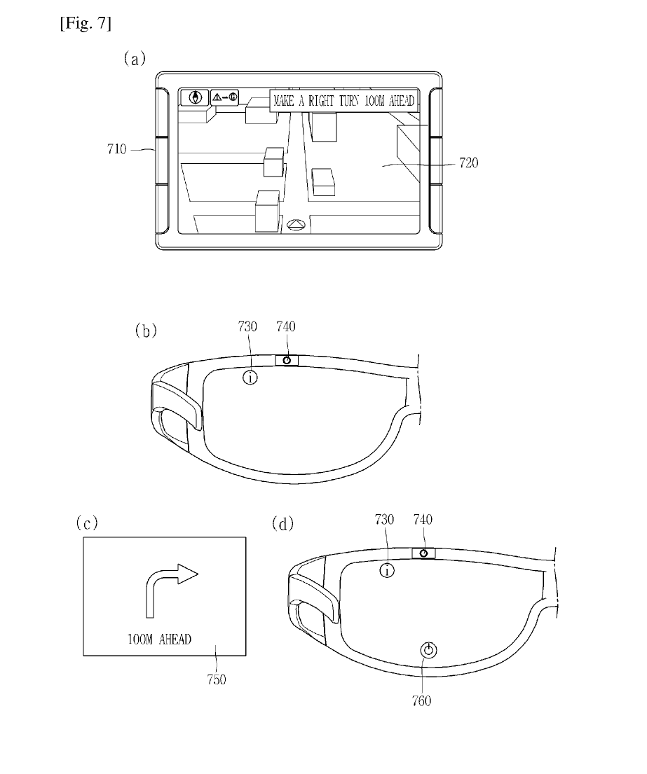

FIG. 6 is a diagram illustrating a user interface through which the display device according to the present invention operates.

Referring to FIG. 6, an indicator 610 indicating an occurrence of an event in the external device and an ending indicator 620 are output on one of the left-eye and right-eye display units 151. Then, video information 630 that corresponds to the indicator 610 is output on the other display unit 151.

In addition, first and second eye tracking cameras 640 and 650 that detect the movements of the wearer's eyes are arranged in the left-eye and right-eye display units 151, respectively. As a result, it is determined that the wearer stares at the indicator 610 or the ending indicator 620 for the predetermined time or more.

Specifically, the first eye tracking camera 640 determines whether the wearer's eye close to a position where the first eye tracking camera 640 is arranged stares at an upper region of the display unit 151, on which the indicator 610 is output, for the predetermined time or more. The upper region of the display unit 151 is set as one region of the display unit 151, including the indicator 610.

In addition, the second eye tracking camera 650 determines whether the wearer's eye close to a position where the second eye tracking camera 650 is arranged stares at the indicator 610 for the predetermined time or more.

Accordingly, when the wearer's eyes stares at the upper region of the display unit 151, on which the indicator 610 is output, and the indicator 610 for the predetermined time or more, the video information 630 corresponding to the indicator 610 is output on the other display unit 151. At this time, the video information 630 is output on only one region of the other display unit 151.

Subsequently, the first eye tracking camera 640 determines whether the wearer's eye close to the position where the first eye tracking camera 640 is arranged stares at a lower region of the display unit 151, on which the ending indicator 620 is output, for the predetermined time or more. The lower region of the display unit 151 is set as one region of the display unit 151, including the indicator 620.

In addition, the second eye tracking camera 650 determines whether the wearer's eye close to the position where the second eye tracking camera 650 is arranged stares at the ending indicator 620 for the predetermined time or more.

Accordingly, when the wearer's eyes stares at the lower region of the display unit 151, on which the ending indicator 620 is output, and the ending indicator 620 for the predetermined time or more, the video information 630 corresponding to the indicator 610 that is output on the other display unit 151 disappears.

For example, the video information 630 that is output disappears, and contents or a home screen that is previously output is output back.

FIG. 7 is a diagram illustrating a display device according to one embodiment, associated with a navigation function.

Referring to FIG. 7(a), content information 720 is newly updated such as a current moving course or real-time traffic information, and the updated content information 720 is output on a mobile terminal or vehicle navigation 710.

Referring to FIG. 7(b), an indicator 730 that corresponds to the content information 720 is one display unit 151.

At this time, tracking cameras 740 (only one is illustrated) which are arranged on opposite sides of the frame of the smart glasses 100, respectively, keep track of the movements of the wearer's left and right eyes and determines whether the wearer stares at the indicator 730 for the predetermined time or more.

FIG. 7(c) is a diagram illustrating the screen 151 when viewed from the wearer.

Referring to FIG. 7(c), when it is determined that the wearer stares at the indicator 730 for the predetermined time or more, the vehicle navigation 710 is requested to transmit the content information 720 and then the content information 720 is received.

Subsequently, video information 750 is generated based on the content information 720 such as the current moving course or the real-time traffic information that is received and the video information is output on the display unit 151. As described above, the video information 750 is output on the display unit 151 other than the display unit 151 on which the indicator 730 is output.

Specifically, the video information 750 is the same as the content information 720 that is output on the vehicle navigation 710 or is output as contents that results from editing the content information 720.

As an embodiment, when real-time traffic conditions are as the content information 720, the video information 750 may be configured using symbols that indicate road conditions more briefly, and thus the video information 750, configured in this manner, may be output.

As another embodiment, when the moving course in which a right turn has to be made 100 m ahead is output as the content information 720, an “arrow” indicating the right direction and “100 m ahead” may be output as the video information 750.

That is, information that is newly updated during a guide is output, as the video information 750, on the display unit 151.

Referring to FIG. 7(d), when it is determined that the wearer stares at an ending indicator 760 that is output on the display unit 151, for the predetermined time or more, the outputting of the video information 750 that is output on the display unit 151 is ended.

As another embodiment, when the wearer stares at empty space on the display unit 151 on which any information is output or when the wearer does not stare at the video information 750 even one time for the predetermined time, the outputting of the video information 750 that is output on the display unit 151 may be ended.

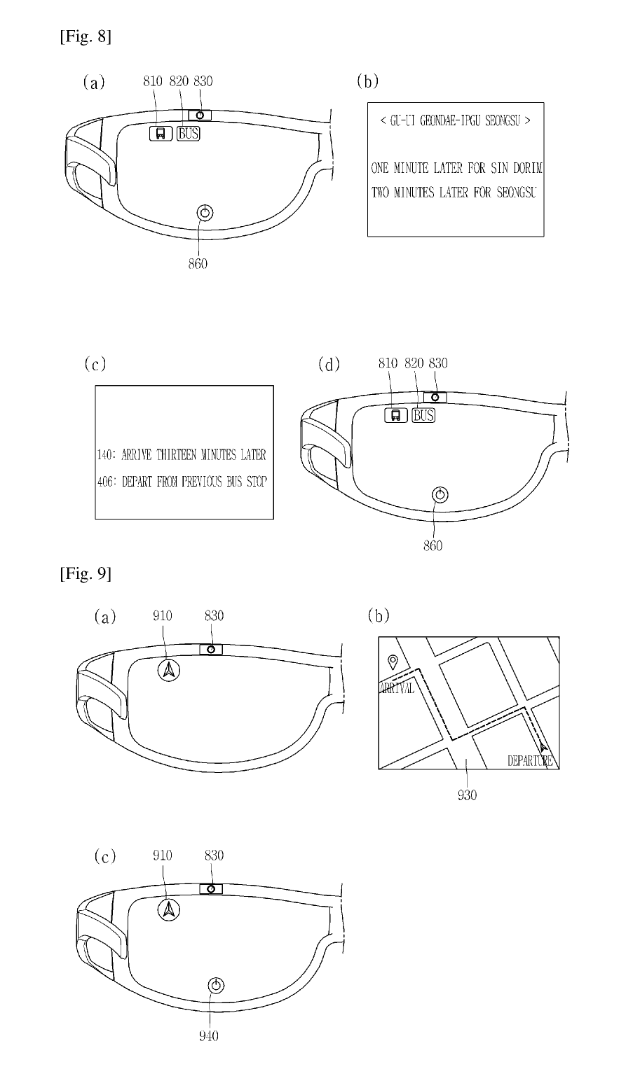

FIG. 8 is a diagram illustrating a display device according to one embodiment, associated with use of public transportation.

Referring to FIG. 8(a), the mobile terminal, the external device, determines whether the wearer stays near a bus stop or a subway station for the predetermined time or more, using a GPS-derived positioning function.

Subsequently, the mobile terminal receives real-time public transportation information associated with a bus and a subway as the content information and then transmits the content information to the smart glasses 100. Accordingly, indicators 810 and 820 associated with the real-time public transportation information are output on one display unit 151 of the smart glasses 100.

As an embodiment, when the wearer stays near the subway station for the predetermined time or more, a subway icon 810 may be output on one display unit 151.

As another embodiment, if the wearer stays near the bus stop for the predetermined time or more, a bus icon 820 may be output on one display unit 151.

As an embodiment, when the wearer stays near the subway station and the bus stop for the predetermined time or more, the subway icon 810 and the bus icon 830 are displayed together on one display unit 151.

Accordingly, the eye tracking cameras 830 (one is illustrated) that are arranged on opposite sides of the frame, respectively, determine whether the wearer stares at the indicators 810 and 820 for the predetermined time or more.

FIGS. 8(b) and 8(c) are diagrams illustrating the screen 151 when viewed from the wearer.

Referring to FIG. 8(b), when it is determined that the wearer stares at the subway icon 810 for the predetermined time or more, subway arrival estimation information 840 is output on the display unit 151 other than the display unit 151 on which the subway icon 810 is output.

Referring to FIG. 8(c), when it is determined that the wearer stares at the bus icon 820 for the predetermined time or more, bus arrival estimation information 850 is output on the display unit 151 other than the display unit 151 on which the bus icon 820 is output.

Referring to FIG. 8(d), an ending icon 860 is output on the display unit 151 on which the subway icon 810 and the bus icon 820 are output together. At this time, when the wearer stares at the ending icon 860 for the predetermined time or more, the subway arrival estimation information 840 and the bus arrival estimation information 850 that are output disappear from the screen 151.

As another embodiment, when the wearer does not stare at the subway arrival estimation information 840 or the bus arrival estimation information 850 even one time for the predetermined time, or when the wearer does not stare at the subway arrival estimation information 840 or the bus arrival estimation information 850 for a given time or more during the predetermined time, the subway arrival estimation information 840 or the bus arrival estimation information 850 may disappear from the screen 151.

FIG. 9 is a diagram illustrating a display device according to one embodiment, associated with way-finding.

Referring to FIG. 9(a), if the wearer desires to be guided for way-finding, a specific control command is input into the smart glasses 100, and an indicator 910 corresponding to the way-finding is output.

As an embodiment, when the wearer blinks three times or more, a way-finding icon 910 may be output on one display unit 151.

Referring to FIG. 9(b), when it is determined that the wearer stares at the way-finding icon 910 for the predetermined time or more, using an eye tracking camera 920, a way-finding application is executed in the mobile terminal.

Subsequently, video information 930 corresponding to the content information provided by the way-finding application that is executed in the mobile terminal.

As an embodiment, a way-finding map 930 that is output in the mobile terminal may be output on the display unit 151 other than the display unit 151 on which the way-finding icon 910 is output. In addition, a current location of the wearer is output on the way-finding map 930, using the GPS-derived positioning function of the mobile terminal.

As an embodiment, if a departure place and a destination place are input into the mobile terminal, a way-fining service screen may be output on the display unit 151 other than the display unit 151 on which the way-finding icon 910 is output.

Referring to FIG. 9(c), when it is determined that the wearer stares at and ending indicator 940 for the predetermined time or more, a way-finding service that is provided in the smart glasses 100 is ended.

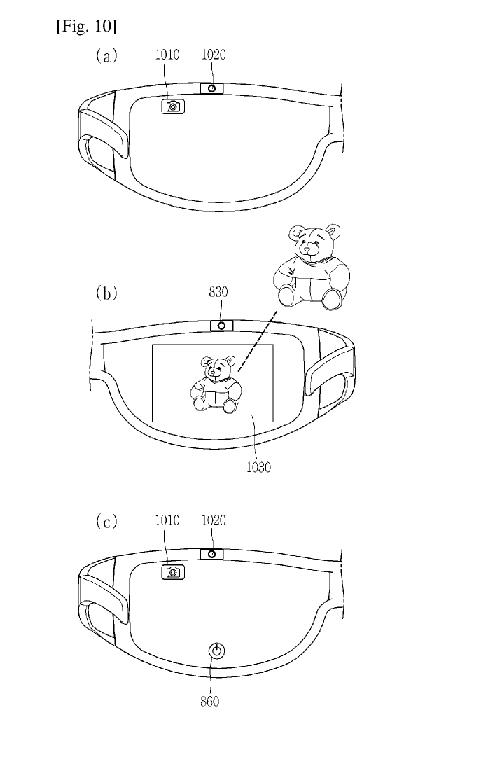

FIG. 10 is a diagram illustrating a display device according to one embodiment, associated with transmission of the screen.

Referring to FIG. 10(a), while a call is in progress on the smart phone, a camera icon 1010 is output on one display unit 151. At this time, through the use of the eye tracking cameras 1020 (only one is illustrated) that are arranged in both of the display units 151, respectively, it is determined whether the wearer stares at a camera icon 1919 for the predetermined time or more.

Referring to FIG. 10(b), a scene 1030 that is seen through the camera 121 is output on the display unit 151 other than the display unit 151 on which a camera icon 1010 is output. Subsequently, the scene 1030 that is output is transmitted to the other party while a call is in progress.

As an embodiment, while a call is in progress, the scene 1030 that is seen through the camera 121 may be transmitted to the other party, in the real-time moving image format that allows the scene to be viewed for a predetermined time.

As another embodiment, the scene 1030 at a specific moment may be transmitted to the other party while a call is in progress.

As another embodiment, a real-time moving image file may be transmitted to the mobile terminal of the other party, or may be transmitted at the email address of the other party that is stored in an address book.

As another embodiment, if the other party wears the smart glasses as well, the real-time moving image may be transmitted directly through the smart glasses of the wearer.

As a result, while a call is in progress, the other party can recognize where the wearer is currently located and whether the wearer is in an urgent situation. In addition, the other party can be guided for way-finding as the wearer moves in a given direction.

Referring to FIG. 10(c), when it is determined that the wearer stares at an ending icon 1040 that is output below the camera icon 1010, for the predetermined time or more, the call is ended.

As another embodiment, when the call to the smart phone is ended, a service for transmitting the content information to the other party may be ended.

On the other hand, the multiple indicators that correspond to the multiple events that occur in the external device, respectively, are output on the display unit 151.

In addition, in order in which the wearer stares at at least one of the multiple indicators for the predetermined time or more, at least one of the items of video information that correspond to at least one of the indicators, respectively, is output on the display unit 151.

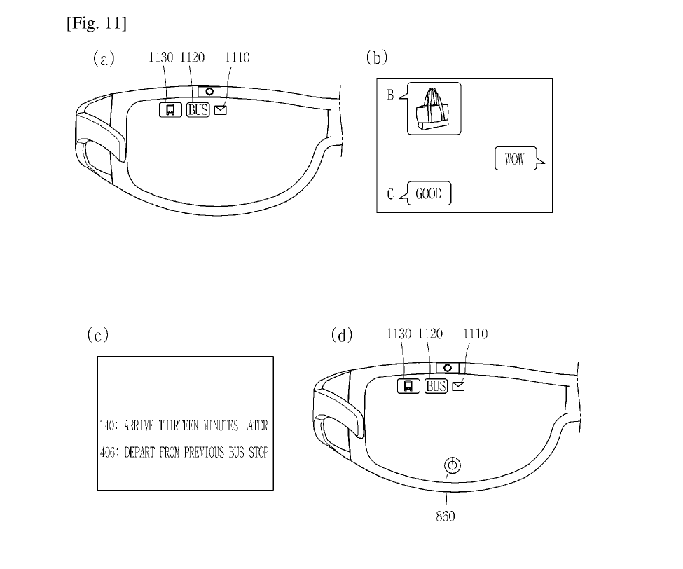

FIG. 11 is a diagram illustrating a display device according to one embodiment, associated with occurrences of the multiple events.

Referring to FIG. 11(a), multiple indicators 1110, 1120, and 1130 that correspond to the multiple events that occur in the mobile terminal are output on the display unit 151. At this time, the multiple indicators 1110, 1120, and 1130 are arranged in order in which the events occur.

As an embodiment, when it is determined that the wearer stays at the bus stop for the predetermined time after the mobile terminal receives the message, a bus icon 1120 may be output after an icon 1110 that corresponds to the receiving of the message is output. Subsequently, when it is determined that the wearer stays at the subway station for the predetermined time or more, a subway icon 1130 is output.

Referring to FIG. 11(b), if the wearer stares at a message receiving icon 1110 for the predetermined time or more, contents 1140 of the received message that corresponds to the message receiving event are output.

Referring to FIG. 11(c), if the wearer checks the contents of the message and then stares back at the bus icon 1120 for the predetermined time, contents 1150 relating to the bus arrival estimation time are output.

As an embodiment, the contents 1150 relating to the bus arrival estimation time may be output above the contents 1140 of the received message that is output earlier. Alternatively, the contents 1150 relating to the bus arrival estimation time are output in parallel together with the contents 1140 of the received message.

Referring to FIG. 11(d), as described above, if the wearer stares at an ending icon 1160 for the predetermined time or more, the previously-output contents disappear.

As an embodiment, if the wearer stares at the ending icon 1160 for the predetermined time or more in a state where the contents 1150 relating to the bus arrival estimation time is output above the contents 1140 of the received message, the contents 1150 relating to the bus arrival estimation time, which are output at the top, disappear earlier. Subsequently, if the wearer stares back at the ending icon 1160 for the predetermined time or more, the contents 1140 of the received message disappear.

As another embodiment, in the state where the contents 1140 of the received message are output, the wearer stares at the ending icon 1160 for the predetermined time or more and thus the contents 1140 of the received message disappear and thereafter when the wearer stares at the bus icon 1120, the corresponding contents may be newly output.

According to the present invention, there is no need for the wearer to apply a separate touch and the like because he/she checks the result of the event that occurs in the external device through the use of the movements of the his/her eyes. In addition, compatibility with various external devices is possible.

As a result, the user convenience can be improved.

In addition, according to one embodiment disclosed in the present specification, the method described above may be realized by being stored as processor-readable codes in a program-stored medium. A ROM, a RAM, a CD-ROM, a magnetic tape, a floppy disk, an optical data storage device and the like are examples of the processor-readable medium, and the processor-readable medium may be realized in the form of a carrier wave (for example, a transmission over the Internet).

With regard to the mobile terminal described above, the configuration and method of the embodiments described above are not given any limitation to their applications, and all of, or some of the embodiments may be selectively combined with each other in a manner that creates various modifications.

With regard to the mobile terminal described above, the configuration and method of the embodiments described above are not given any limitation to their applications, and all of, or some of the embodiments may be selectively combined with each other in a manner that creates various modifications.

1. A display device comprising:
a main body formed in such a manner that the main body can be head-mounted;
a display unit arranged in a position that corresponds to left and right eyes configured to display an indicator indicating an occurrence of an event in an external device; and
a controller configured to display video information that corresponds to the event that occurs in the external device to the display unit when it is determined that a wearer stares at the indicator for a predetermined time or more.

2. The display device of claim 1, wherein when it is determined that the wearer stares at the indicator for the predetermined time or more,
the controller configured to request the external device to transmit content information that is output in the external device according to the occurrence of the event and receives the content information.

3. The display device of claim 2, wherein the controller configured to generate the video information that corresponds to the event that occurs in the external device, based on the received content information, and to display the generated video information to the display unit.

4. The display device of claim 1, wherein when it is determined that the wearer stares at an ending indicator that is output on the display unit, for the predetermined time or more, the controller configured to end the displaying the video information.

5. The display device of claim 5, further comprising:
an eye tracking camera configured to determine whether the wearer stares at the indicator that is output on the display unit, for the predetermined time or more, by keeping track of movements of the wearer's eyes.

6. The display device of claim 1, wherein the display unit further configured to display the multiple indicators that correspond to the multiple events, respectively, which occur in the external device, and the controller configured to display at least one of the items of video information that corresponds to at least one of the indicators, respectively, to the display unit in order in which the wearer stares at at least one of the multiple indicators for the predetermined time or more.

7. A method of controlling a display device that is capable of being head-mounted, comprising:
a step (a) of displaying an indicator indicating an occurrence of an event in an external device;
a step (b) of determining whether a wearer stares at the indicator for a predetermined time or more; and
a step (c) of displaying video information that corresponds to the event that occurs in the external device to the display unit, when it is determined that the wearer stares at the indicator for the predetermined time or more.

8. The method of claim 7, wherein the step (c) includes:
requesting the external device to transmit content information that is output in the external device according to the occurrence of the event, and
receiving the content information, when it is determined that the wearer stares at the indicator for the predetermined time or more.

9. The method of claim 8, wherein the step (c) includes:
generating the video information that corresponds to the event that occurs in the external device, based on the received content information, and
displaying the generated video information on the display unit.

10. The method of claim 7, wherein the step (d) includes:
ending the displaying the video information, when it is determined that the wearer stares at an ending indicator that is displayed to the display unit, for the predetermined time or more.

11. The method of claim 7, wherein the display device that is capable of being head-mounted comprises an eye tracking camera configured to t determine whether the wearer stares at the indicator that is displayed to the display unit, for the predetermined time or more, by keeping track of movements of the wearer's eyes.

12. The method of claim 7, wherein the step (a) includes displaying the multiple indicators that correspond to the multiple events, respectively, which occur in the external device,
wherein the step (b) includes determining whether the wearer stares at at least one of the indicators for the predetermined time or more, and wherein the step (c) includes displaying at least one of the items of video information that corresponds to at least one of the indicators, respectively, to the display unit, in order in which the wearer stares at least one of the multiple indicators.
